(19) United States
(12) Patent Application Publication
(10) Pub. No.: US 2006/0142933 A1
(43) Pub. Date: Jun. 29, 2006

(54) Intelligent traffic system

(76) Inventor: Lumin Feng, Beijing (CN)

Correspondence Address: HARNESS, DICKEY, & PIERCE, P.L.C, 7700 BONHOMME, STE 400, ST. LOUIS, MO, 63105, US

(21) Appl. No.: 10/535,392

(22) PCT Filed: Nov. 18, 2003
(86) PCT No.: PCT/CN03/00978

§ 371 Date: Nov. 8, 2005

(30) Foreign Application Priority Data
Nov. 18, 2002 (CN) 02148610.7

(51) Int. Cl. G08G 1/00

(52) U.S. Cl. 701/117

(57) ABSTRACT

The present invention discloses an intelligent traffic system. The system at least comprises a traffic control center, a traffic information service center, a cellular mobile communication system, a road toll collection system and an in-vehicle terminal, which are connected with each other via a wired communication network. The in-vehicle terminal communicates with the traffic control center, the road toll collection system and the traffic information service center respectively via the cellular mobile communication system. The present invention further claims an in-vehicle terminal used in an intelligent traffic system and a method for realizing an intelligent traffic system with a cellular mobile communication system. By adopting the intelligent traffic system, its construction cost will be reduced greatly.

### FIELD OF THE INVENTION

The present invention relates to an intelligent traffic system (ITS), more particularly, to a vehicle intelligent traffic system that is constructed on the basis of a commercial cellular mobile communication system, and has brand-new information acquisition and information service means.

### BACKGROUND OF THE INVENTION

The Chinese patent application NO. 97195528.X, entitled “Vehicle Navigation System”, discloses an automatic toll collection and lane selection prompting system installed near a toll station. This system can prompt the payment ability of the payment account of a driver for the toll at the toll station ahead, and provide the driver with the selection prompting information for driving toward an automatic toll collection lane or a manual toll collection lane, at an area near the toll station, to eliminate the jam near an open toll station.

Presently, in the world, there are more and more in-vehicle terminal products developed based on the mode of GPS+GSM or GPS+CDMA. The mobile data collection vehicles currently used in Europe adopt this kind of in-vehicle terminals. But this kind of products can only operate in the manner of continuously sending information of the present vehicle to a central station at changeable time intervals by means of a cellular communication network for the purpose of reflecting the track and velocity of the subject vehicle, and are widely used in vehicle theft prevention and vehicle dispatch.

The core of an intelligent traffic system includes information acquisition, information processing, information supplying, information utilization and toll collection without vehicle stopping. In an existing intelligent traffic system solution, the functions, such as information acquisition, information supplying, toll collection without vehicle stopping and toll collection management, are implemented on different technical platforms, which results in a complicated system structure, high construction cost and restricted means and ability of information acquisition. Especially, information acquisition is a part of the intelligent traffic system that has the highest cost and the biggest difference between performance and expectation; therefore the price/performance ratio of the whole system is aggravated.

### SUMMARY OF THE INVENTION

One object of the present invention is to provide an intelligent traffic system, which can utilize an existing cellular mobile communication system network, be constructed on the single technical platform of cellular mobile communication system, and is a solution to implement the main functions of ITS by brand-new means of information acquisition and information service based on the characteristics of cellular communication technology.

The intelligent traffic system according to the present invention, at least comprises a road system and an in-vehicle system, in which the road system at least comprises a traffic control center, a cellular mobile communication system, and the in-vehicle system comprises at least an in-vehicle terminal, characterized in that the communication between the road system and the in-vehicle terminal is established by means of the cellular mobile communication system, information acquisition and information services for vehicles are implemented in the manner of information points and information areas, and tolls are collected without vehicle stopping, the information acquisition and information services in the manner of information points and information areas being a form of information acquisition and information services in which only when the position passed by a vehicle or the area where the vehicle is situated is located at a position or an area specified by the traffic control center, the in-vehicle terminal of the vehicle executes the instructions corresponding to the position or the area issued by the traffic control center.

The present invention further provides an in-vehicle terminal used in the intelligent traffic system. The in-vehicle terminal according to the present invention at least comprises: a central processing unit, a parameter input module, a communication module, a memory, a prompting unit, in which the parameter input module, the communication module, the memory and the input/output unit are connected to the central processing unit, and the parameter input module at least comprises a GPS module, the communication module at least comprises a cellular communication module, the input/output unit at least comprises a speech synthesis unit, characterized in that the GPS module at least receives positioning signals from a satellite, the cellular communication module is used to establish the communication between the in-vehicle terminal and the road system, the central processing unit can at least process position parameters of the present vehicle from the parameter input module, and when the position parameters indicate that the present vehicle is situated at the position and area specified by an instruction, extracts the information specified by the instruction from the memory and outputs it via the communication module or the input/output unit according to the requirements of the instruction.

The characteristics of the present invention consist in that the whole intelligent traffic system is constructed on a single technical platform of a cellular mobile communication system, entirely utilizing existing techniques in technical combination to realize the functions such as traffic information acquisition, traffic information services, toll collection without vehicle stopping, vehicle identification, vehicle navigation with road condition information, reservation of and ushering within parking lots, commercial and emergency vehicle assistance, and road-vehicle communication, etc., which simplifies the acknowledged ITS architecture greatly.

The advantages of the present invention consist in centralization of system hardware devices, rapid system construction, convenient maintenance and updating, reducing greatly or avoid the heavy system construction and use cost, and shortening the system construction time. Also the in-vehicle terminal platform is open and hence many applications can be accessed.

### BRIEF DESCRIPTION OF THE DRAWINGS

FIG. 1 is a block diagram showing the architecture of an intelligent traffic system according to the present invention;

FIG. 2(a) is a block diagram showing a complete structure of an in-vehicle terminal according to the present invention;

FIG. 2(b) is a block diagram showing a simplified structure of an in-vehicle terminal according to the present invention;

FIG. 3(a) is a block diagram showing an exemplary structure of a traffic control system;

FIG. 3(b) is a block diagram showing an exemplary structure of a traffic information service center;

FIG. 4(a) is a block diagram showing an exemplary structure of a vehicle traveling assistance system;

FIG. 4(b) is a block diagram showing an exemplary structure of a vehicle management system;

FIG. 5(a) is a block diagram showing the structure of a road toll collection system;

FIG. 5(b) is a schematic diagram showing a pattern of traveling route determined by a subscribed navigation service displayed on the in-vehicle terminal;

FIG. 6 is a schematic diagram showing the application of the present invention in a specific area;

FIG. 7 is a schematic diagram showing a virtual display image of the road condition information obtained by the information acquisition;

FIG. 8 is a schematic diagram showing the process of an implementation of the toll collection without vehicle stopping.

In the drawings:

1. in-vehicle terminal; 10. central processing unit; 11. GPS module; 111. DGPS module; 12. cellular communication module; 121. FM broadcasting additional channel digital receiver module; 13. memory; 131. present vehicle property information; 132. present vehicle dynamic information; 14. input/output unit; 141. speaker; 142. microphone; 143. display screen; 144. light signal unit; 145. number and function keyboard; 146. external interface; 147. digital-analog speech module;

2. traffic control center; 20. computer system; 21. intelligent traffic system application software; 22. cellular mobile communication network interface; 23. GIS road network map system; 24. traffic signal device control network; 25. network storage device; 26. traffic information service center interface; 27. vehicle management system interface; 211. road traffic control system; 212. traffic information acquisition system; 213. road signal control system; 214. DGPS unit;

3. traffic information service center; 30. computer system; 31. traffic information service application software system; 311. vehicle road navigation system; 312. road condition information supply system; 313. call center system; 32. traffic control center interface; 33. cellular mobile communication network interface; 34. network storage device; 35. call center system interface; 36. road toll collection system interface;

4. cellular mobile communication system; 40. mobile switching center; 41. cell; 411-414. cell; 42. user identification number; 421. cellular mobile terminal machine number; 422. mobile communication user number; 43. trunk between a cellular base station and a mobile switching center; 431-434. trunk between a cellular base station and a mobile switching center; 44. cell boundary; 441-443. boundaries between adjacent cells; 45. base station; 451-454. base station; 46. wired data communication line; 461-466. wired data communication lines between the computer systems of various parts of the system;

5. vehicle traveling assistance system; 50. vehicle traveling computer and software system; 51. commercial vehicle assistance system; 52. emergency vehicle assistance system; 53. official vehicle assistance system; 54. traffic control center interface; 55. cellular mobile communication system interface; 56. road toll collection system interface;

6. vehicle management system; 60. vehicle management computer and software system; 61. vehicle registration database; 62. network storage device; 63. traffic control center interface; 64. cellular mobile communication system interface; 65. road toll collection system interface;

7. road toll collection system; 70. road toll collection computer and software system; 701. road toll collection settlement system; 71. wired data communication network special for toll stations; 72. toll station computer system; 721. toll station image recognition system device; 722. toll station image recognition software; 723. image recognition video camera; 73. toll collection midline; 74. traffic control center interface; 75. cellular mobile communication system interface; 76. vehicle management system interface;

8. coordinates in the information of a toll station prompting information point; 81. center of a circular pre-selected area in the simple area acquisition method; 82. coordinates in the information of a traffic temporary control sign information point; 83. data acquisition area of the simple direct area method or an information point;

9. road sign; 901-916. road sign group of the predetermined traveling route of vehicle V;

C. crossing; D. data acquisition area of the double precision and three stage screening method; D0. data acquisition area of the direct area method; D1, D3. data acquisition area before a toll station; D2, D4. data acquisition area after a toll station; E. destination; F. starting point; S. toll station; V. vehicle.

### DETAILED DESCRIPTION OF THE INVENTION

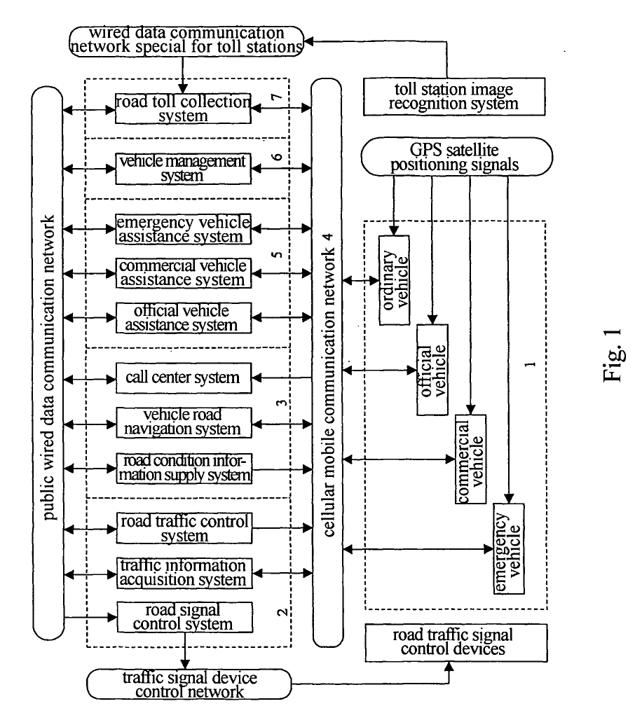

A preferred embodiment of the present invention will now be described with reference to the drawings. As shown in FIG. 1, the system of the present invention comprises an in-vehicle system and a road system, the in-vehicle system comprising an in-vehicle terminal (1), and the road system comprising a traffic control center (2), a traffic information service center (3), a cellular mobile communication system (4), a vehicle traveling assistance system (5), a vehicle management system (6), and a road toll collection system (7). Wherein, the traffic control center (2), the traffic information service center (3), the cellular mobile communication system (4), the vehicle traveling assistance system (5), the vehicle management system (6) and the road toll collection system (7) are interconnected via wired remote digital communication lines. The traffic control center (2), the traffic information service center (3), the cellular mobile communication system (4), the vehicle traveling assistance system (5), the vehicle management system (6) and the road toll collection system (7) are connected with the in-vehicle terminal (1) in the manner of wireless digital communication via the cellular mobile communication system (4)

Various parts of the system will now be described:

Traffic Control Center (2)

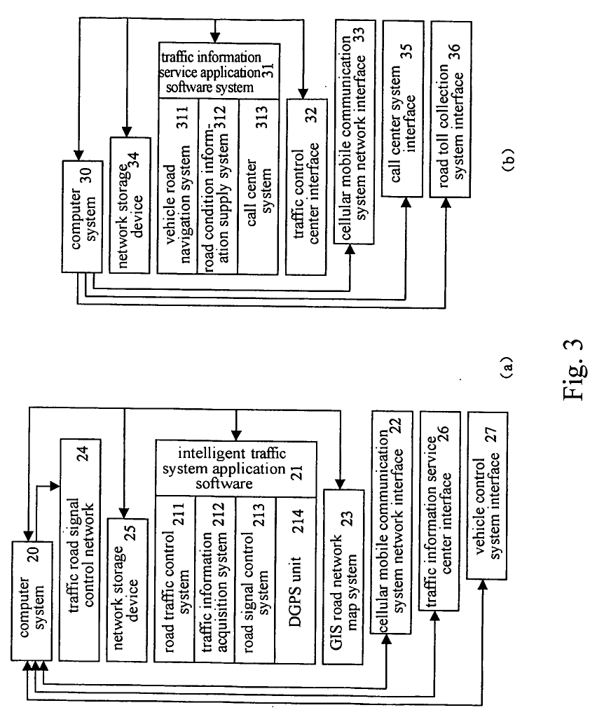

As shown in FIG. 3 (a), the traffic control center (2) comprises a computer system with powerful computational processing capability, intelligent traffic system application software and a network storage device. The intelligent traffic system application software is supported by powerful database software. A GIS road network map system (23) mapping a real road network system is an important tool and operation interface by which the traffic control center (2) maintains traffic order of the district with computer systems.

A road traffic control system (211) can revise the control rules of any crossing's traffic signal and so on in time via a road signal control system (213), based on the result of the information acquisition for the road conditions of the whole district road network by a traffic information acquisition system (212) and with reference to the data about the navigation service subscription by the user from a vehicle road navigation system (311) and the information provided by the vehicle assistance system (5) and the road toll collection system (7), and then download the revised control rules to road traffic signal control devices via a traffic signal device control network (24). Alternatively, it can issue temporary control measures concerning some road crossings or sections, and broadcast the temporary control measures to the vehicles in the associated areas by means of setting information points and via a road condition information supply system (312).

The road traffic control system (211) is the enforcement system for road network traffic rules, also the formulation system for the road traffic temporary control measures and the database storing the placement positions, the content settings, modifications and temporary changes of every traffic signs in the whole road network system. If the traffic facilities or control rules of any road crossing or section vary, the road traffic control system (211) will record the variation before it is approved to be implemented, and the road condition information supply system (312) will make all the participants of the road traffic know the variation of the facilities or rules at the first time.

The road traffic control system (211) is further equipped with a high-precision GIS road network map system and route computation software, to undertake the task of the computation of coordinate conversion and traveling path from the traffic information service center (3), the vehicle management system (6), the road toll collection system (7) and the vehicle assistance system (5).

The traffic information acquisition system (212) collects the traffic road condition information of the whole road network by means of area acquisition method and information point acquisition method. The information acquisition can be the data acquisition for the parameters such as road passing traffic volume and vehicle speeds for real-time requirements, and also can be the acquisition of the overall information of the traffic distribution of the whole road network system.

The acquisition content of traffic information mainly is the acquisition of the present vehicle dynamic information (132), and together with the present vehicle property information (131) if necessary. The extracting time in the present vehicle dynamic information (132) is the time when a central processing unit (10) extracts the position coordinates from a GPS module (11). After receiving the present vehicle dynamic information (132), the traffic information acquisition system (212) can extract the GPS coordinate precision-adjusted values of the same time from a DGPS unit (214) so as to adjust the position coordinates in the present vehicle dynamic information (132). The adjustment precision can be within 1 meter, so as to provide the technical guarantee for the virtual display of the traffic conditions of road crossings or sections very well.

Traffic Information Service Center (3)

As shown in FIG. 3(b), the center similarly has powerful computation capability, powerful database software and network storage device (34), and also has a call center system interface (35) and interfaces (32), (33), (36) used to communicate with other closely related systems.

The traffic information service center (3) obtains road condition information and road traffic control information needed by user from the traffic control center (2) and road toll standards from the road toll collection system (7). A call center system (313) subordinate to the traffic information service center (3) receives service requests from divers and records these requests into the system, to be processed by the computer system of the traffic information service center (3).

Traffic information service application software (31) comprises a vehicle road navigation system (311), a road condition information supply system (312) and a call center system (313). It is not necessary to provide route computation software and the GIS road network map system in the traffic information service center (3). This is because the country has strict regulations with regard to the management of high precision electronic maps, so it is necessary to restrict electronic maps with the national defense security level needed by the system to the traffic control center (2). When other related systems request for this kind of data, they can send requests to the computer system of the traffic control center (2).

The call center system (313) is a service entity for receiving navigation subscription requests in the form of speech or data information from users. The navigation subscription requests from users, which may be in the form of short message etc., can be submitted to the traffic information service center (3) via the cellular mobile communication system (4).

The traffic information service center (3) can broadcast the content of the information services in the form of data via the cellular mobile communication system (4) and the additional channel of a traffic broadcast station.

Cellular Mobile Communication System (4)

Since the operating principle of a cellular mobile communication system (4) is well known, here there will be no more description of it.

When an in-vehicle terminal (1) crosses a cell boundary, a mobile switching center (40) will send the information concerning all the information points having been set in the base station service area into which it entered to the in-vehicle terminal (1). The information of these information points will be managed in the form of version number. The information version number obtained by the present vehicle is sent together with the signaling sent to the base station by the in-vehicle terminal (1) of the vehicle, so as to reduce the repeated transmissions of the information of the information points due to the vehicle repeatedly going in and out of the base station.

When a or a set of new information points are set in a certain base station service area, the mobile switching center (40) can issue the information of these information points in the manner of broadcasting the information of the information points to all the vehicles in the present service area immediately or broadcasting to the vehicles entering thereafter according to the instructions of the traffic control center (2).

Each vehicle is provided with an in-vehicle terminal (1), and has a unique identification number belonging to the cellular mobile communication system (4) as an electronic license plate. There are usually two user identification numbers (42) associated with the cellular mobile terminal, which can be served as electronic license plates: one is the mobile terminal hardware machine code (421) IMEI, the other is the cellular mobile user number (422).

The present preferred embodiment takes the cellular mobile user number (422) as the electronic license plate of a vehicle.

The cellular mobile user number (422) also has a payment account in the cellular mobile communication system (4). This account can be used to settle charges such as vehicle road tolls, breach penalties and so on in the manner of advance payment or in the manner of monthly settlement as used by common mobile telephone user.

Vehicle Traveling Assistance System (5)

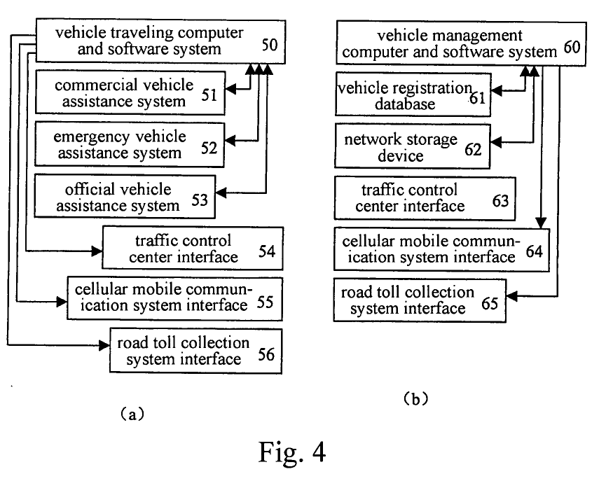

FIG. 4 is a block diagram showing the structure of the vehicle traveling assistance system (5). The vehicle traveling assistance system (5) has similar functions with the traffic information service center (3), and is an entity for providing traffic information services especially for specialized or commercial vehicles.

The vehicle traveling assistance system (5) comprises a commercial vehicle assistance system (51), an emergency vehicle assistance system (52) and an official vehicle assistance system (53). These systems cover a taxicab assistance system, a freight vehicle assistance system, an ambulance assistance system, and assistance systems for official vehicles, military vehicles and police vehicles. Various industries can establish their own industry vehicle assistance systems according to the characteristics of the industries, on the basis of the abundant information resources provided by the traffic control center (2) and the traffic information service center (3) and by means of the tools that can be made public or authorized by the system, and can establish information connection with the traffic control center (2), and invoke system resources under certain privilege with payment or free under the authorization of the traffic control center (2) and the vehicle management system. The vehicle traveling assistance system (5) also can invoke the information resources in the system of the traffic information service center (3).

Vehicle Management System (6)

FIG. 4(b) is a block diagram showing the structure of the vehicle management system (6). The vehicle management system (6) is constructed on the basis of an existing vehicle management system (6). The system provides vehicle registration information for other systems, and provides the service of query of the relationship between the physical license plate and electronic license plate of a vehicle for the toll collection system (7) etc. under system authorization, and it is also the pursuit execution entity for pursuing vehicles evading fees (taxes and fees such road tolls, road maintenance fees and vehicle and ship taxes, etc).

The vehicle management system (6) can manage vehicles and parking lots on the same level, and the key difference between them is the way of naming. Examples of the numbers of vehicles and parking lots in the vehicle management system (6) are as follow:

| | Vehicle | Parking lot |
|---|---|---|
| Physical license plate | BJ AE5XXX | 1234-JEN |
| Electronic license plate | 91012345678 | 90110123456 |
| Mobile communication | 91012345678 | 90110123456 |
| user number | | |
| Cellular mobile | 5350017370296xx | 5350017370296yy |
| communication system | | |

(4) Identification Number (IMEI)

The computer system identifies the nature of each traffic object based on this kind of difference. When the computer system determines the object to be a parking lot or other traffic facilities, the content of the property information and dynamic information format common with vehicles will be processed differently.

If the electronic license plate of a vehicle is concealed, the vehicle will be traveling in a concealed state, so that the information of information points that should be downloaded may not be downloaded normally, which will cause toll evasions by the vehicle at road toll stations and information acquisition inaccuracy of the traffic information acquisition system (212). Therefore it must be ensured that electronic license plates of vehicles have the legal management as strict as that of physical license plates. The punishment to a vehicle that conceals the electronic license plate is as serious in nature as the punishment to a vehicle that conceals the physical license plate.

The vehicle management system (6) can monitor the online condition of the electronic license plate of any vehicle by means of the mobile terminal login identification function of the cellular mobile communication system (4). If the in-vehicle terminal (1) of a vehicle is powered off or its cellular communication module (12) fails, the mobile communication system (4) will inform the vehicle management system (6) immediately by means of the function of checking that the user's mobile phone is shut down or out of the service area. When the in-vehicle terminal (1) of the vehicle resumes communication, the mobile communication system (4) will also inform the vehicle management system (6) immediately. As a result, the vehicle management system (6) can know the amount of vehicles in the whole road network in real time and frighten against the behavior of concealing the electronic license plate.

Road Toll Collection System (7)

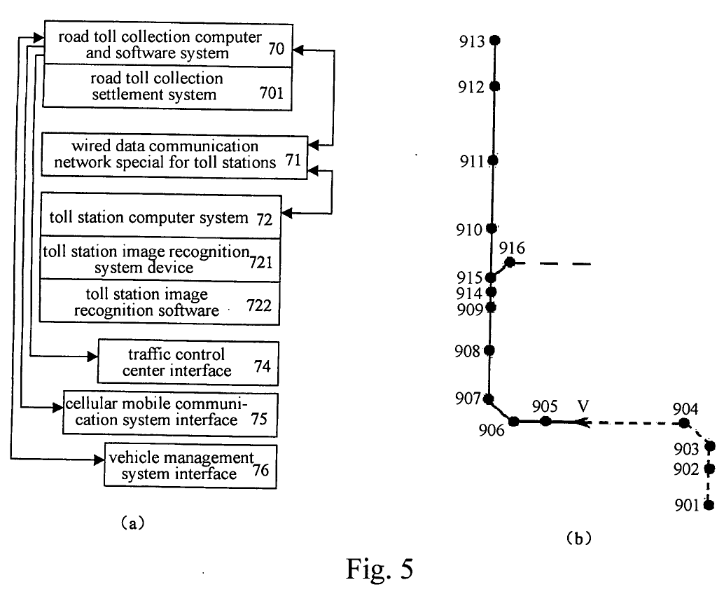

FIG. 5 is a block diagram showing the structure of the road toll collection system (7). The road toll collection system (7) is located in a central station and road toll collection settlement system (701) software is running in its road toll collection computer and software system (70). The other parts of the system comprise a wired data communication network special for toll stations (71) connected to the computer system (72) of every toll station, the toll station computer system (72) located in every toll station and the interfaces to other systems (74), (75) and (76).

The toll stations belonging to different owners have their own toll station computer systems (72), toll station image recognition system devices (721) and toll station image recognition software (722). Each toll station captures the pictures of passing vehicles with its self-provided toll station image recognition video camera (723), identifies the physical license plates of the vehicles, and then includes them into an intraday settlement report made by the toll station computer system (72) together with the vehicle passing times, and transmits this report to the road toll collection computer and software system (70) via the wired data communication network special for toll stations (71).

The road toll collection settlement system (701) is located in the central station. The settlement operation can also be entrusted to the cellular mobile communication system (4) to be implemented by its existing user telephone fee settlement system.

The road toll collection computer and software system (70) store the legal toll standards of all the toll stations. The system is an independent financial settlement unit, in charge of inspecting and checking the toll confirmation information sent back by the vehicle when it is passing a toll station and the settlement report sent by the toll station computer system (72). If the toll confirmation information of a vehicle is received and the license plate number and the passing time of the vehicle are also included in the settlement report, the road toll collection computer and software system (70) will send the toll confirmation corresponding to the vehicle to a road toll collection settlement system (701) to perform toll settlement.

The toll confirmation information sent by a vehicle comprises the current GPS coordinates, the electronic license plate, the traveling direction and the passing time of the vehicle and the code number of the toll station.

In-Vehicle Terminal (1)

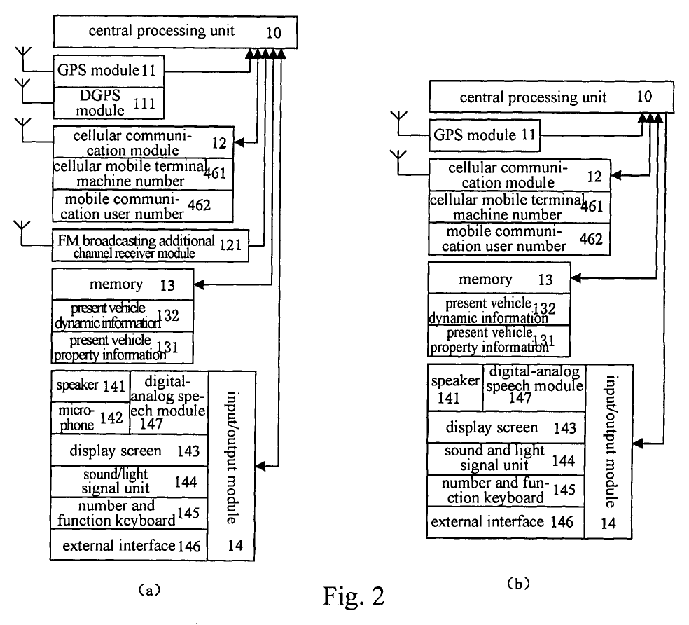

FIG. 2 is a block diagram showing the structure of an in-vehicle terminal (1) of the present invention. FIG. 2(a) shows the complete structure of the in-vehicle terminal (1). An in-vehicle terminal (1) with complete structure comprises a central processing unit (10), a GPS module (11), a DGPS module (111), a cellular communication module (12), a FM broadcasting additional channel receiver module (121), a memory (13), a digital-analog speech module (147), an input/output unit (14), a speaker (141), a microphone (142), a display screen (143), a sound/light signal unit (144), a number and function keyboard (145) and an external interface (146).

FIG. 2(b) shows a simplified in-vehicle terminal (1) of low cost.

The GPS module (11) receives satellite positioning signals, provides parameters such as position coordinates, traveling speed, and traveling direction and so on, to the present vehicle and creates dynamic information of the present vehicle. After generating the position coordinates, the GPS module (11) outputs them to the central processing unit (10). The coordinates are compared with the sequence of coordinate values and the corresponding effective ranges related to the information of a series of information points in the memory (13) by the central processing unit (10). When the straight line distance between the coordinates of the present vehicle and certain coordinates is less than the value of the effective range, the central processing unit (10) extracts the prompting information of the information point corresponding to these coordinates from the memory (13) and transmits this information to the input/output unit (14) according to its properties.

If the prompting information corresponding to the coordinates is speech information in the form of text, the prompting information will be played as speech by a speaker (141) after converted by a digital/analog speech module (147); if the prompting information corresponding to the coordinates is of the nature of image, the information will be transmitted to a display screen (143) directly and displayed; and if the prompting information corresponding to the coordinates is of the nature of sound or light signals, the information will be transmitted to a sound/light signal unit (144) and presented. The sound/light signal unit (144) gives simple prompting information to drivers in the form of simple sound signals and light flickering in place of speech.

The external interface (146) can connect with the mobile phone carried by the driver, and also can connect with an external storage or load new data into the memory (13). The external interface (146) even can connect with the turning rod of the direction indicator lamps of the vehicle for monitoring the wrong veering operation of the driver and alarming in advance. The presupposition is that the vehicle must be traveling under the guidance of navigation road signs.

All the contents that can be downloaded via the cellular communication module (12) and the FM broadcasting additional channel digital receiver module (121) can be loaded by connecting an external storage to the external interface (146), which can be a way of information initialization of the in-vehicle terminal (1).

A mobile phone connected via the external interface (146) has the same functions as the number and function keyboard (145). If there is no number and function keyboard (145) equipped on the in-vehicle terminal (1), a mobile phone connected to the in-vehicle terminal (1) can serve as a number and function keyboard (145). But in this case, the driver can set information on the mobile phone and then transmit it into the memory (13) via the external interface (146), hence enabling the driver to set traveling routes by himself.

When the in-vehicle terminal (1) receives the instruction to return the GPS coordinates of the present vehicle from the traffic control center (2) via the cellular communication module (12), the central processing unit (10) will extract the present vehicle dynamic information (132) according to the time required by the instruction and then create immediately the information frame to be returned to the traffic control center (2) and store it into the memory (13). The in-vehicle terminal (1) will send this information frame back to the traffic control center (2) via the cellular communication module (12) at the first time when it can be sent.

The in-vehicle terminal (1) further comprises an alarm/alarm clear button. The button at least has the function of raising an alarm to the traffic control center (2) and an emergency hospital. Pressing the button again will clear the alarm. The alarm is sent together with the information of the GPS coordinates, the physical license plate and the body color of the present vehicle, by which the alarm receiving entity can find the vehicle.

The signal source for the DGPS (111) can be the digital information broadcasting embedded in the FM broadcasting additional channel. The digital information broadcasting can insert the DGPS adjusted coordinate information between the common broadcastings of traffic road condition information.

There is a cellular communication system mobile terminal user identification number (42) built in the cellular communication module (12). The number also is one form of the electronic license plate of a vehicle, and is managed and used the same as the physical license plate by the vehicle management system (6).

The property information (131) and the dynamic information (132) for the present vehicle are stored in the memory (13).

The present vehicle property information (131) comprises:
1. position coordinates;
2. vehicle electronic license plate;
3. other optional vehicle registration items, such as the body color and so on;
4. extracting time;
5. vehicle model code.

The present vehicle dynamic information (132) comprises:
1. position coordinates;
2. traveling speed;
3. traveling direction;
4. extracting time;
5. vehicle model code.

The two kinds of information mentioned above compose a five-section information format. This format can be used as a standard information format in the road-vehicle communication.

The traffic control center (2) also can perform unidirectional or bi-directional speech communication directly with the in-vehicle terminal (1) by means of the speaker (141) and the microphone (142) via the cellular communication module (12) and the input/output module (14) under the intervention of the central processing unit (10) and based on instructions. The in-vehicle terminal (1) with the anti-robbery feature enabled also allows bi-directional speech communication with the driver registered with the system, monitoring and shouting to stop illegal activities.

The in-vehicle terminal (1) is equipped with a FM broadcasting additional channel digital receiver module (121), which is used to receive the digital broadcasting information carried on the sideband of the public broadcasting frequency of the local traffic information specialized broadcasting station.

The traffic information acquisition of the present invention can be carried out by the area acquisition method and the information point acquisition method. The area acquisition method is an instruction for one-off collecting, which is mainly used to acquire the local or overall traffic volume distribution information. The area acquisition method mainly includes the double position precision and three stage screening method and its improved methods.

1. Double Position Precision and Three Stage Screening Method

Since the method is disclosed in the Chinese patent application NO. 02149001.5, here there will be no more description of it.

The double position precision and three stage screening method can be used in an information acquisition area to calculate statistics of the information of the vehicles in the area. And this method is comparatively suitable to be used in the temporary traffic jam investigation and so on.

2. Direct Area Method

The traffic information acquisition system (212) also can adopt an improved double precision and three stage screening method.

An area of arbitrary shape in which the information acquisition need to be performed is determined in a GIS map mapping a real road network system and is represented in a mathematical form. Then the area represented by the mathematical form is sent to all the vehicles in the service area of the base station and the in-vehicle terminals (1) which have received the mathematical expression of the area are commanded to judge whether the present vehicles are in the area based on the GPS values of the present vehicles. If the present vehicles are in the area, the information of the present vehicles will be sent back, otherwise they will keep silence.

If a rectangular area can be represented by A (x1, y1, z), B (x2, y2, z), C (x3, y3, z), D (x4, y3, z) and the parameters of the expression are linear, the information acquisition area will be reproduced by connecting the four points with straight lines in the above order according to this mathematical expression.

The direct area method has the advantages of the least feedback vehicles in the cellular service area and the least latter processing. But it has the complicated mathematical expression issued for designating an area and the longest word length of the downloaded information frame.

3. Simple Direct Area Method

The simple direct area method is another improved direct area method, and has more similarities with the information point information acquisition method. With respect to the information point information acquisition method, unlike the simple direct area method, the acquisition instruction can be stored in the memory (13) permanently and still effective after the vehicle responses only once in a specified time interval. But in the simple direct area method and the above-mentioned area acquisition method, the acquisition instruction need not be stored in the memory (13) and are used only once.

A pre-selected area with the simplest mathematical form that includes the specified area, such as a pre-selected area of a circular shape that covers the specified area, can be issued in the base station service area covering the target area. The definition method of the mathematical expression of the area is the same as that of an information point. The pre-selected area should cover the specified area completely. The in-vehicle terminals (1) in the pre-selected area send back the present vehicles information, and then the traffic information acquisition system (212) determines which vehicles are in the specified area and further performs processing and statistics for the vehicles in the specified area. That is to say, the specified area is the real information acquisition area required by the system.

The improved direct area method has the advantages of simple description content of the area issued, less information to send back and less processing in the late stages.

The information point acquisition method is a kind of acquisition instruction which can be repeated for many times, and is mainly used to monitor the information such as the traveling speed and so on of vehicles passing any crossing or section.

Information Point Information Method

An information point is a position described by coordinates and their effective range. The information point information is an information combination of an information point and the operation of the information point. It is an executive instruction for an in-vehicle terminal (1). When the coordinates of the present vehicle output by the GPS module (11) in the in-vehicle terminal (1) enters the effective range of the coordinates of a certain information point stored in the memory (13), the central processing unit (10) triggers the operation corresponding to this information point.

The information point information includes, for example:
1. the coordinates of the information point;
2. the effective range of the information point;
3. the type of the triggered operation of the information point;
4. the content of the information point information;
5. the operation time for the content of the information point.

A road sign is a form of information point. A series of information points arranged in sequence are needed when the information points are used for vehicle navigation. Therefore the information points used for navigation are called road signs. The information content of each road sign is the guidance information for traveling to the next road sign. Thus a road sign sequence corresponding to the traveling route is generated. It is directly referred to as a traveling route when used in the GIS application and can be subscribed and downloaded from the traffic information service center (3) by a driver.

The information content of an information point can be in one of the following exemplary forms:
i) outputting the guidance information for traveling from this information point to the next information point, such as “turn left”, “turn right” or “go straight”;
ii) invoking a leading traveling route road sign group associated with the information point and inserting it into the road sign sequence of the existing traveling route;
iii) outputting a piece of prompting information for road toll collection associated with the information point;
iv) a multimedia file of MP3 of MPEG formats;
v) outputting a piece of prompting information that has the same content as the traffic sign located here;
vi) outputting a piece of shipper information to be informed to the truck passing by;
vii) outputting a piece of speech prompting information determined by the driver and associated with the information point;
viii) invoking a detour route determined by the driver and associated with the information point;
ix) triggering the specified operation according to the requirements of information point setting by the traffic control center (2).

When a vehicle is moving, the coordinates of all the information points are entered into a data stack, and arranged in the order of the distance between each information point and the vehicle. The central processing unit (10) will update the arrangement order of the information point coordinates in the stack periodically. The present vehicle is closest to the information point whose coordinates are pointed to by the stack pointer.

Some specific traffic information acquisition processes according to the information acquisition methods mentioned above are exemplified as follow:

Active Acquisition

Aiming at a determined crossing or section, a traffic control person specifies an outline of the crossing or the section with a width of road width and a specified length according to the direction of the curb of the crossing or the section on the interface displaying the GIS road network map, so as to form a closed line figure represented as the top view of the outline of the crossing or the section. This closed line figure is the specified information acquisition area.

When it is confirmed that the traffic information is to be collected in this specified area, an instruction associated with information acquisition is sent out via the base station whose service area covers the real crossing or section, and received by the in-vehicle terminals (1) of all the vehicles in the service area of the base station. A piece of time information can be included in the instruction to request the in-vehicle terminals (1) of all the vehicles which have received the instruction to extract the present vehicles information at the time specified by the instruction and send it back to the traffic control center (2).

The instruction format for the information acquisition using the double positioning precision and three stage screening method can be exemplified as follows:
1. coordinates: (base station number);
2. effective range: 0;
3. type of triggered operation: B (returning information);
4. operation content: (present vehicle property information or dynamic information);
5. operation time: (YY/MM/DD) tt/mm/ss.

The instruction format for the direct area method can be exemplified as follows (the area is presented by a hollow cross-shaped line figure of a crossing):
1. coordinates: (base station number);
2. effective range: (type of method—direct area method, type of connection—straight line connection, x1, y1, z1; x2, y2, z2; x3, y3, z3; x4, y4, z4; x5, y5, z5; x6, y6, z6; x7, y7, z7; x8, y8, z8; x9, y9, z9; x10, y10, z10; x11, y11, z11; x12, y12, z12);
3. type of triggered operation: B (returning information);
4. operation content: (present vehicle dynamic information or property information);
5. operation time: tt/mm/ss.

This mode is very suitable for grasping the jam condition or evaluating the influence of emergencies on the traffic before traffic policemen arrive.

The traffic control center (2) will process the returned information mentioned above as follows:
1. determining one by one which vehicles are in the specified area according to the returned GPS coordinates after adjustment by the DGPS unit (214);
2. calculating statistics on the vehicles in the specified area;
3. invoking the 3D models of the vehicles determined to be in the specified area;
4. displaying these models on the amplified specified area of the GIS map according to the respective data of positions and directions sent back by the vehicles;
5. the three-dimensional virtual view displaying the specified area can be changed according to an arbitrary point of view.
   Passive Acquisition

Another way of traffic information acquisition is to set an information acquisition point at a traffic information sensitive position at the specified crossing or section on the GIS road network map.

An information acquisition point is also a form of application of information points. When a vehicle is passing an area with a radius of no less than half of the road width and a circle center coordinates of (xxxx, yyyy), the information operation at the point downloaded to the in-vehicle terminal (1) in advance is triggered. The central processing unit (10) of the in-vehicle terminal (1) creates return information and sends it back to the traffic control center (2) according to the operation content of the information point immediately.

The format of the information acquisition point can be exemplified as follows:
1. coordinates: xxxx, yyyy, zzzz; (position of the information point)
2. effective range: 20; (range)
3. type of triggered operation: returning information; (description of the instruction type)
4. operation content: present vehicle dynamic information; (content of the information)
5. operation time: 0. (returning time) The traffic control center (2) can know the passing speed of the vehicles at a specified position at the crossing or the section after receiving the information frame. In a similar way, all the information that can be provided by an in-vehicle terminal (1) can be acquired.

With the present method, the positions of the information acquisition points can be changed arbitrarily without any additional construction cost incurred by means of the base station facilities of the cellular mobile communication system (4), and many types of information can be collected. Any information that can be provided by an in-vehicle terminal (1) may be collected by means of the present method and the area acquisition method.

Overall Information Acquisition Method:

It is very helpful for grasping and analyzing the traffic condition of the whole road network to be able to obtain the traffic flow distribution information of the whole road network system in the district at the same time.

The traffic information acquisition system (212) can send in advance the request to acquire all the road condition information of the whole road network at several specified acquisition times in a day to the memory (13) of each in-vehicle terminal (1). When a vehicle is traveling normally in the road network system, the in-vehicle terminal (1) extracts the present vehicle information at a specified time, makes the information into an information frame and pre-stores it into the memory (13). When the communication service of the cellular mobile communication system (4) is in idleness, the information returning process of all the information frames pre-stored in all the in-vehicle terminals (1) is activated by the traffic control center (2).

Part of the functions and implementation methods of the embodiments mentioned above will now be described by way of examples.

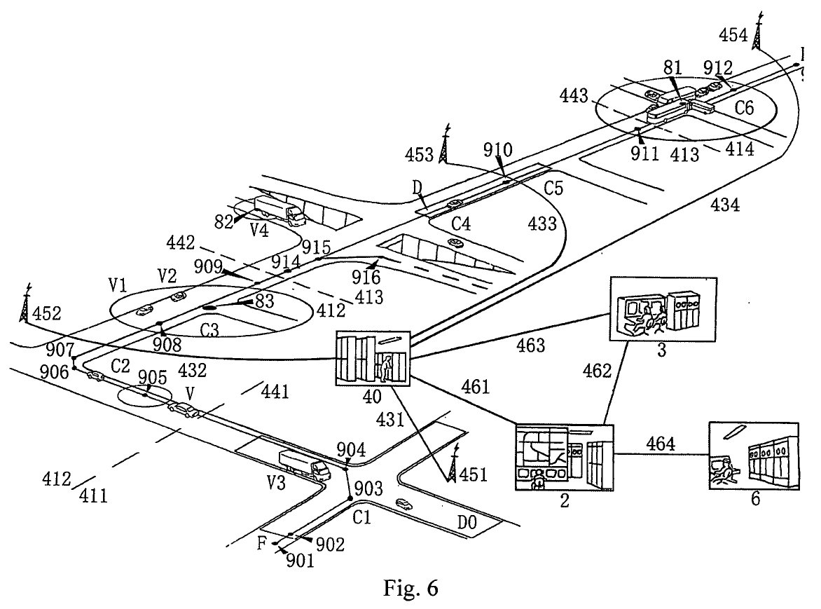

FIG. 6 is a schematic diagram showing a specific application of the present invention.

FIG. 6 shows a part of a road network system, wherein the driver of a vehicle (V) uses a mobile phone carried by him to report the information of subscribing navigation service by the present vehicle to the vehicle road navigation system (311) of the traffic information service center (3), and the information includes:
1. physical license plate and password of the present vehicle;
2. starting point (F) and destination (E).

The traffic information service center (3) selects several calculated routes as pre-selected routes according to the report of the driver and performs information retrieval about the crossings or sections related to each pre-selected route. The results of the information retrievals are attached to the pre-selected routes as route properties and downloaded to the in-vehicle terminal (1). The driver then determines one of the pre-selected routes as an executive traveling route according to the route properties, and the in-vehicle terminal (1) sends the number of the executive traveling route back to the vehicle road navigation system (311).

When the traveling route is viewed, the pattern displayed on the display screen (143) of the in-vehicle terminal (1) is shown as in FIG. 5(b). This traveling route consists of a series of road signs. These road signs will be displayed on a display screen with text format as follow:

| crossing | direction |
|---|---|
| C1 | turn left |
| C2 | turn right |
| . . . | . . . |
| C5 | Go straight |
| C6 | Go straight |

These road signs are described in the in-vehicle terminal (1) as follow:

| number of a road sign | effective range | prompting information |
|---|---|---|
| 901 | 16 meters | go north along the road |
| 902 | 16 meters | turn left at the crossing |
| | | 50 meters ahead |
| . . . | . . . | . . . |
| 912 | 16 meters | destination 100 meters |
| | | ahead |
| 913 | 16 meters | reach the area of |
| | | destination |

The whole property of this route can be described as: 4 Km, 18 min; effective period of time 16:23-15:00; six crossings, one turning left, one turning right;

If somebody wants to know the route property in details, he/she will find the information as follows:

| | | switching of signal |
|---|---|---|
| section | average speed | lamp |
| before C1 | 32 Km/h | waiting C1 signal for |
| | | 20 sec |
| between C2 and C1 | 33 Km/h | waiting C2 signal for 0 |
| . . . | . . . | . . . |
| between C6 and C5 | 32 Km/h | waiting C6 signal for |
| | | 25 sec |
| after C6 | 22 Km/h | |

A jam occurs at the crossing (C6) due to a traffic accident after the vehicle (V) sets out according to the selected traveling route. The traffic control center (2) then broadcasts this road condition information to the circumjacent base stations including the base station (453) of the service area (414) of the base station (454) in which the crossing lies. Since the boundary (443) is so close to the crossing (C6), the base station (452) is also included in the downloading scope.

The broadcasting content corresponding to the road condition information of the crossing (C6) issued by the traffic control center (2) is stored at the entry of the base station (452) in the mobile switching center (40) in advance. After the vehicle (V) logging in the base station (452), the mobile switching center (40) will download the road condition information to the in-vehicle terminal (1) of the vehicle (V) via the base station (452).

In the individualized traffic information service, the vehicle road navigation system (311) retrieves the issued navigation routes via a wired communication line connected with the traffic control center (2) immediately after receiving the road condition information associated with the crossing (C6). The navigation routes that contain the crossing (6) are selected and the mobile communication system user numbers (422) of the in-vehicle terminals (1) that have subscribed these navigation routes are extracted at the same time. The road condition information is sent to the in-vehicle terminals (1) represented by these mobile communication system user numbers (422), so that the drivers are informed with speech, and a suggestion for changing the traveling routes can be provided to the vehicles (v). The suggested detour route that is downloaded can be as follows:

| | | |
|---|---|---|
| number of road sign | effective range | prompting information |

| | | |
|---|---|---|
| 914 | 16 meters | turn right at the crossing |
| | | 40 meters ahead |
| 915 | 12 meters | turn right at the present |
| | | crossing |
| 916 | 12 meters | finish turning |
| . . . | . . . | . . . |

The new traveling route will be inserted following the road sign (908), so as to guide the vehicle (V) along the new route from a duplex crossing to the destination (E). If the driver agrees to the detour solution, he/she can press the key of “#” on the number and function keyboard (145) of the in-vehicle terminal (1), the detour route then will be inserted into the original traveling route and the road signs after the road sign (909) are invalidated.

In FIG. 6, the effective range of the road sign (905) is 16 meters, and is represented by the scope of a fine line circle. When the vehicle (V) enters the area of the circle, the in-vehicle terminal (1) will believe that the vehicle (V) has gotten to the road sign (905) and output the prompting information of the road sign 905 immediately.

A coach has a rear-end collision with a car ahead at the crossing (C6). The in-vehicle terminals (1) of both vehicles send alarms within 10 seconds to the drivers respectively, and store the information such as the traveling coordinates and speed during the 15 seconds before the alarm at the same time. Simultaneously, the in-vehicle terminals (1) prompt the drivers to confirm whether or not to clear the alarms to the traffic control center (2) and an emergency hospital. If the drivers themselves are not wounded in the accident, only the handling by the traffic control center (2) is needed without that of the emergency hospital, so the drivers can merely clear the alarm to the emergency hospital respectively and wait for the handling of the traffic control center (2).

The traffic control center (2) will start the communication with the in-vehicle terminal of the front vehicle immediately after receiving the alarms of the two vehicles, and have a talk with the driver of the front vehicle via the microphone (142) to confirm the occurrence of the accident. Then the traffic control center (2) immediately informs traffic policemen nearby to go to handle it.

The traffic control center (2) also invokes the information of the in-vehicles terminals (1) of the two vehicles stored before the alarm as evidences for handling the accident later, and displays the top view of the models and the position relationship of the two vehicles on a large screen according to the coordinates returned by the vehicles after adjustment by the DGPS unit (214), finding a partial overlapping between the front end and the rear end of the vehicle outlines. Then it will confirm whether the undercarriage and the engine of the rear vehicle is in the overlapping and whether the engine of the front vehicle is rear positioned based on the overlapping degree and the model data further invoked, in order to judge whether the front and rear vehicles can leave the accident location by themselves, and then determine whether or not to dispatch a tractor after talking with the drivers for confirmation. Subsequently, the traffic control center (2) will set the simple area acquisition method at the crossing (C6) to evaluate the jam scale due to the accident.

A coordinate (81) is set at the center of the crossing (C6) to define a scope for information acquisition with a radius of 500 meters. The vehicles within this area will send the property information (131) and the dynamic information (132) of them to the traffic control center (2) immediately. The traffic control center (2) then selects all the vehicles at the crossing (C6) road surface according to the real plane shape of the crossing (C6) and the coordinates of each vehicle after adjustment by the DGPS unit (214), invokes the model of each vehicle based on the present vehicle property information (131) and displays the virtual three-dimensional image of the crossing (C6) in the large screen of the traffic control center (2).

An information point (83) with an effective range of 50 meters is set at the crossing (C3) by the traffic control center (2), as shown in FIG. 6. The set content of the information point is for investigation of the traffic flow volume of a road section, which is:

| | |
|---|---|
| 1. X83, Y83, #; | coordinates of information point |
| 2. 15 (meter) | effective range of information point |
| 3. B (returning information) | triggered operation action type of |
| | information point |
| 4. D (vehicle dynamic information) | information content of information |
| | point |
| 5. 0 (returning at once) | operation time of content of |
| | information point |

The vehicles (V1), (V2) return the respective vehicle dynamic information according to the requirement of the information point, which is:

| | |
|---|---|
| Vehicle (V1): | |
| 1. Xv1, Yv1 | position |
| 2. 60(km/h) | traveling speed |
| 3. 179.5° | direction |
| 4. 10:00:00/04/13/2008 | time |
| 5. VSVW03 (Volkswagen 03) | model code |
| Vehicle (V2): | |
| 1. Xv2, Yv2 | position |
| 2. 57(km/h) | traveling speed |
| 3. 180.5° | direction |
| 4. 10:00:01/04/13/2008 | time |
| 5. VSAD02 (Audi 02) | model code |

The set content of the information point (83) has been downloaded into the in-vehicle terminals (1) of the passing vehicles via the base station (452) and the adjacent base stations (453) and (451) in advance.

In FIG. 6, a rectangle traffic information acquisition area (D) is set on the unidirectional carriageway between the crossing (C4) and the crossing (C5). As a result, the information of the vehicles possibly traveling to the crossing (C6) can be extracted by the double position precision and three stage screening method, and an emergency advance warning can be sent to these vehicles according to the extracted electronic license plates of the vehicles.

In FIG. 6, the traffic control center (2) further sets an information acquisition area D0 using a complicated form of the direct area method at the crossing (C1). The mathematical description of the information acquisition area is downloaded into the in-vehicle terminal (1) of the vehicle (3) as an information acquisition instruction via the base station (451) or (452). When the vehicle (V3) reaches this information acquisition area, the present vehicle property information (131) and the dynamic information of the vehicle (V3) are transmitted to the traffic control center (2). Because of the laws and regulations for privacy protection, the traffic control center (2) does not extract the physical license plate of the vehicle. The traffic control center (2) finds that the vehicle (V3) is a heavy truck forbidden to travel in this area at this period of time from the vehicle model code within the present vehicle property information (131) of the vehicle (3), and then reports it to the vehicle management system (6) according to its electronic license plate. Then the vehicle management system (6) queries for the physical license plate of the vehicle and records the event into the breach record of the vehicle.

The vehicle (V4) shown in FIG. 6 is also a heavy truck. It has downloaded the traffic sign information group of the area from the base station (453) when it entered the service area (413) of the base station (453). When the vehicle (V4) reaches the crossing (C4), it has passed the information point (82), which has an effective range with a radius of 10 meters. The in-vehicle terminal (1) prompts “No right-turn at this crossing for heavy vehicles”, so as to remind the driver of the vehicle (V4) to avoid the breach of regulation. The passing vehicles can be prompted to abide the regulations for temporary traffic control by means of the information point information.

The information point information triggered by the vehicle (V4) is in the form as follows:

The format of the information point information can be as follows:

| | | |
|---|---|---|
| 1. | X82, Y82, Z82 | coordinates of information point; |
| 2. | 10 (meter) | effective range of information |
| | | point; |
| 3. | Ii | triggered operation type of |
| | | information point; |
| 4. | “No right-turn at this crossing | information content of information |
| | for heavy vehicles” | point; |
| 5. | (heavy truck) | parameter content of Ii instruction. |

Wherein, “Ii” is an individualized information service instruction with a parameter specifically referring to heavy trucks. As a result, the information will not be triggered when a car is passing.

Assumes that a specific vehicle electronic license plate is specified in the parameter. When the in-vehicle terminal (1) triggers the information point, the central processing unit (10) extracts the electronic license plate of the present vehicle and compares it with that in the instruction parameter according to the instruction, so as to determine whether or not to play the information content of the information point.

The traffic control center (2) can download in advance the content specified by the overall information acquisition method in the form of instruction to the in-vehicle terminals (1) of all the vehicles registered with the vehicle management system (6). The form of the instruction can use the format of the information point information. The format of the instruction can be exemplified as follows:

| 1. blank | coordinates of information point; |
|---|---|
| 2. blank | effective range of information point; |
| 3. BS | triggered operation type of information point; |
| 4. D | information content of information point; |
| 5. 8, 9, 10 | operation time of content of information point. |

Wherein, the coordinates and the effective range of the information point are blank, suggesting to the in-vehicle terminals (1) that the instruction may belong to the overall information acquisition. The type of the triggered operation further points out that the returning information belongs to the form of “storage return (represented by BS) of the overall information acquisition. The time of information acquisition is specified to be at 8 o'clock, 9 o'clock and 10 o'clock of the day. Once the acquisition time comes, the in-vehicle terminal (1) extracts the specified present vehicle dynamic information (132) and stores it into the memory (13).

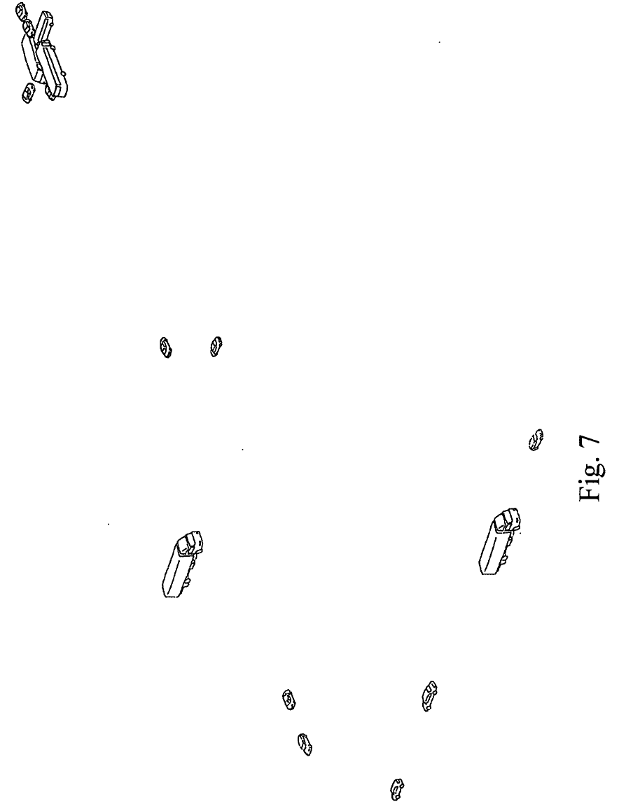

A virtual reality scene of the part of road shown in FIG. 6 can be displayed in a large-scale screen after processed by the traffic control center (2). It will be the situation shown in FIG. 7, if the traffic road condition information is extracted at 10 o'clock.

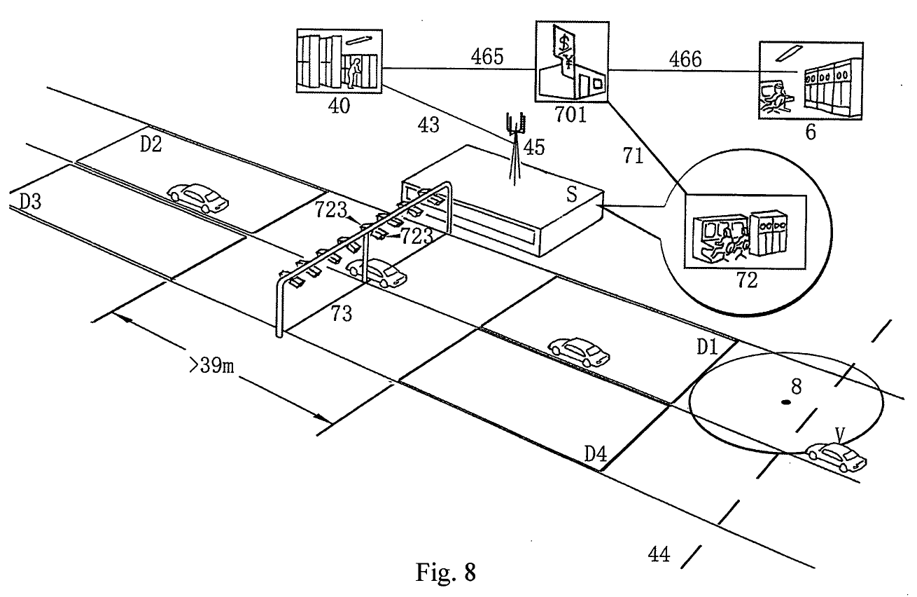

FIG. 8 shows the process of toll collection without vehicle stopping implemented by a toll station adopting the present preferred embodiment.

An open highway toll station (S) is located in the service area of the base station (45). The antenna of the base station is located on the building near the gate of the toll station. The service area of the base station has a radius of 1 km, so it will take 25 seconds for a vehicle with a speed of 140 km/h to travel from the edge of the service area to the toll station midline (73). The vehicle flow volume of the toll station is assumed to be 8 vehicles per second for one direction, and in case of four lanes, the average distance between two adjacent vehicles is 39 meters, the time interval between two adjacent vehicles is one second.

The vehicle (V5) has downloaded the information associated with the toll station when it is passing the boundary (44) between the service areas of the base station (45) and the adjacent base station.

The information associated with the toll station includes information acquisition areas (D1) and (D2) located on either side of the toll station respectively on a unidirectional lane, information point information for prompting (8) and information on the toll standard of the toll station. The shapes of the information acquisition area before toll station (D1) and the information acquisition area after toll station (D2) are corresponding to the plane shape of the highway on either side of the toll station respectively, and are spread on one side of the highway midline and on either side of the toll station midline (73) respectively.

Assumes that the output cycles of the GPS module (11) are twice per second. When the vehicle (V5) reaches the information point (8), the in-vehicle terminal (1) prompts, “You have reached XX highway toll station, and your toll standard is fifteen yuan”. When the vehicle (V5) reaches the data acquisition area before toll station (D1), it will stay in D1 for at least 0.5 second. That is the requirement for the size of D1. At that time the central processing unit (10) starts the process of toll collection and records the time when the vehicle (V5) reached the area (D1).

The time when the vehicle reaches the information acquisition area after toll station (D2) is at least one second later than the time when it passed the area (D1). And the in-vehicle terminal (1) will record the time when the vehicle passed the area (D2) and can display the prompting information “confirm a toll of 15 yuan” on selection. The in-vehicle terminal thereby determines the current position of the vehicle (V5) has passed the toll station midline (73), and sends out a short message for toll confirmation to the road toll collection settlement system (701).

At this time the toll station image recognition system device (721) located in the toll station captures the images of the front and the rear of the vehicle (V5) and identifies the license plate of the vehicle in one second.

The toll station computer system (72) creates a toll report based on the information on the vehicle license plate and transmits it to the road toll collection settlement system (701) via the wired data communication line special for the toll station (71).

After receiving the information for toll confirmation of the vehicle via the wired data communication line (43), the road toll collection settlement system (701) retrieves the physical license plate of the vehicle in the vehicle management system (6) based on the mobile communication system user number (422) of the cellular communication module (12) of the vehicle via the wired data communication line (466), and checks the information for the physical license plate of the vehicle in the toll report, and then records the toll of 15 yuan in the mobile communication system user payment account of the vehicle. The user of the vehicle can pay the road toll in the manner of advance payment or monthly settlement.

The architecture of the intelligent traffic system according to the present invention can be learned through the above description of the preferred embodiments and the examples of function implementation process of the present invention. Apparently, technicians in the art can readily implement the present invention with different specific structures without departure from the spirit and the scope of the present invention, and create many various forms of application or forms of information acquisition and information service according to the principle of the present invention.

1. An intelligent traffic system, at least comprising a traffic control center, a traffic information service center, a cellular mobile communication system, a road toll collection system and an in-vehicle terminal, characterized in that the traffic control center, the traffic information service center, the cellular mobile communication system, and the road toll collection system are connected to each other via a wired communication network; the traffic control center communicates with the in-vehicle terminal via the cellular mobile communication system, to send instructions and information to the in-vehicle terminal and receive the intrinsic information and the dynamic information of the vehicle provided by the in-vehicle terminal; the road toll collection system communicates with the in-vehicle terminal via the cellular mobile communication system to perform toll settlement; and the traffic information service center communicates with the in-vehicle terminal via the cellular mobile communication system.

2. The intelligent traffic system according to claim 1, further comprises a vehicle traveling assistance system and a vehicle management system, the vehicle traveling assistance system and the vehicle management system are connected to the traffic control center via a wired communication network; the vehicle traveling assistance system and the vehicle management system communicate with the in-vehicle terminal via the cellular mobile communication system.

3. The intelligent traffic system according to claim 2, wherein the vehicle management system can be a part of the traffic control center.

4. The intelligent traffic system according to claim 2, wherein the vehicle traveling assistance system can be a part of the vehicle management system.

5. The intelligent traffic system according to claim 1, where the traffic control center comprises a traffic information acquisition system (212).

6. An in-vehicle terminal for an intelligent traffic system, which comprises: a central processing unit (10), a GPS module (11), a cellular communication module (12), a memory (13), a speech synthesis module (14), an output module (15), a number and function keyboard (16), an external interface (17), a display screen (18) and a sound/light signal unit (19), wherein the GPS module (11), the cellular communication module (12), the memory (13), the output module (15), the input unit (16), the external interface (17), the prompting unit (18,19) are connected to the central processing unit (10), characterized in that the GPS module (11) at least receives the position coordinates of the present vehicle from a satellite and provides it to the prompting unit via the central processing unit (10), and the central processing unit at least generates the real-time information of the present vehicle; the cellular communication module (12) at least communicates with a traffic control center via a cellular mobile communication system and at least provides the real-time information of the present vehicle to the traffic control center; the cellular communication module (12) further communicates with a traffic information service center via a cellular mobile communication system, receiving related information, and can request the traffic information service center to provide the information needed.

7. The in-vehicle terminal according to claim 6, wherein the cellular communication module (12) further communicates with a road toll collection system via the cellular mobile communication system to perform toll settlement.

8. An in-vehicle terminal for an intelligent traffic system, which comprises: a central processing unit (CPU) (10), a GPS module (11), a cellular communication module (12), a memory (13), a speech synthesis module (14), an output module (15), a number and function keyboard (16), an external interface (17), a display screen (18), a sound/light signal unit (19) and a FM broadcasting additional channel digital communication module (121), wherein the GPS module (11) at least receives the position coordinates of the present vehicle from a satellite; the central processing unit (10) is used to generate the real-time information of the present vehicle; the cellular communication module (12) is used to communicate with a traffic control center to exchange information; the FM broadcasting additional channel digital communication module (121) is used to receive the digital information carried on the sideband of the public broadcasting frequency of a local traffic information specialized broadcasting station.

9. A method for realizing the object of an intelligent traffic system by using the functions of a cellular mobile communication system, which comprises the following steps:
at least establishing a traffic control center, a traffic information service center, and a road toll collection system;
setting an in-vehicle terminal in the vehicle to be managed by the system;
connecting the traffic control center, the traffic information service center, and the road toll collection system with a wired network;
establishing wireless connections between the traffic control center and the in-vehicle terminal, the traffic information service center and the in-vehicle terminal, and the road toll collection system and the in-vehicle terminal via a cellular mobile communication system and exchanging information via the cellular mobile communication system.

10. The method according to claim 9, wherein the traffic control center comprises a traffic information acquisition system (212) for collecting the information required by the traffic control center with various methods of information acquisition.
